(19) United States
(12) Patent Application Publication
(10) Pub. No.: US 2021/0304218 A1
(43) Pub. Date: Sep. 30, 2021

(54) AUTOMOBILE REGULATION BASED ON DISTRIBUTED LEDGER

(71) Applicant: FUJITSU LIMITED, Kawasaki-shi (JP)

(72) Inventors: Mehdi BAHRAMI, Santa Clara, CA (US); Masami MIZUTANI, Mountain View, CA (US); Wei-Peng CHEN, Fremont, CA (US)

(73) Assignee: FUJITSU LIMITED, Kawasaki-shi (JP)

(21) Appl. No.: 16/836,849

(22) Filed: Mar. 31, 2020

(51) Int. Cl. G06Q 30/00; G06K 9/00; H04L 29/08; H04L 29/06

(52) U.S. Cl. CPC G06Q 30/018; H04L 63/08; H04L 67/12; G06K 9/00791

(57) ABSTRACT

An electronic device receives a first report from a first communication device. The first report is related to a first incident associated with a first vehicle corresponding to the first communication device. The electronic device further receives a second report from a set of second communication devices that lie within a first zonal range of the first vehicle. The electronic device further transmits the first report and the second report to a distributed ledger communicatively coupled to the electronic device. The electronic device further generates consensus information to validate the first incident, based on a smart contract, the received first report, and the received second report. The electronic device further generates a conclusive incident report related to the first incident based on the generated consensus information and generates regulation information based on one of the conclusive incident report, the first report, or the second report, stored on the distributed ledger.

### FIELD

The embodiments discussed in the present disclosure are related to automobile regulation based on distributed ledger.

### BACKGROUND

Recent advancements in the field of vehicles have led to development of various techniques related to automation of the vehicles. Due to autonomous vehicles still being in the development phase, there may be certain risks associated with the autonomous vehicles, such as occurrence of certain incidents due to faults associated with the autonomous vehicle and/or nearby other vehicles. Thus, the vehicles need to be regularized to mitigate certain risks through better control, planning, coordination, and human interaction with the vehicles.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

According to an aspect of an embodiment, an electronic device may be provided. The electronic device may comprise a processor that may be configured to receive a first report from a first communication device. The first report may be related to a first incident which may be associated with a first vehicle corresponding to the first communication device. The processor may be further configured to receive a second report from each of a set of second communication devices different from the first communication device. Each of the set of second communication devices may lie within a first zonal range of the first vehicle. The second report may be related to the first incident associated with the first vehicle. Further, the processor may be configured to transmit the first report received from the first communication device and the second report received from one or more of the set of second communication devices to a distributed ledger communicatively coupled to the electronic device. Furthermore, the processor may be configured to generate consensus information to validate the first incident, based on a smart contract, the received first report, and the received second report. The smart contract executed on the distributed ledger may be associated with each of the first communication device and the one or more of the set of second communication devices. Moreover, the processor may be further configured to generate a conclusive incident report related to the first incident based on the generated consensus information.

According to an aspect of another embodiment, operations operated in an electronic device may include receiving a first report from a first communication device. The first report may be related to a first incident which may be associated with a first vehicle corresponding to the first communication device. The operations in the electronic device may further include receiving a second report from each of a set of second communication devices different from the first communication device. Each of the set of second communication devices may lie within a first zonal range of the first vehicle. The second report may be related to the first incident associated with the first vehicle. Further, the operations may include transmitting the first report received from the first communication device and the second report received from one or more of the set of second communication devices to a distributed ledger communicatively coupled to the electronic device. Furthermore, the operations may include generating consensus information to validate the first incident, based on a smart contract, the received first report, and the received second report. The smart contract executed on the distributed ledger may be associated with each of the first communication device and the one or more of the set of second communication devices. Moreover, the operations may further include generating a conclusive incident report related to the first incident based on the generated consensus information.

The objects and advantages of the embodiments will be realized and achieved at least by the elements, features, and combinations particularly pointed out in the claims.

Both the foregoing general description and the following detailed description are given as examples and are explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 is a diagram representing an example environment related to determination of automobile regulation based on distributed ledger, by an electronic device;

FIG. 2 is a block diagram that illustrates an exemplary electronic device for determination of automobile regulation based on distributed ledger;

FIG. 3 illustrates an exemplary scenario to depict a first incident associated with a first vehicle,

FIGS. 4A-4C collectively illustrate a sequence diagram to depict determination of automobile regulation based on distributed ledger; and

FIG. 5 illustrates a flowchart of an example method for determination of automobile regulation based on distributed ledger,

all according to at least one embodiment described in the present disclosure.

### DESCRIPTION OF EMBODIMENTS

The implementation of regularization for the vehicles requires collection of certain information associated with the vehicle, such as details of the incident, for example, cause of incident and location of incident. However, in certain situations, the collated information related to the incidents may include irrelevant information, fake information, malicious information and the like. Such incorrect information may lead to application of false or inaccurate regulation for the vehicle. In certain other situations, the collated information about the incidents may also be utilized by different parties, such as insurance companies, government agencies, automobile manufactures, traffic authorities and so forth to make any investigation about the incident of the vehicle. Further, the utilization of incorrect information about the incident may also lead to inappropriate investigation performed by the associated party. Thus, an advanced system may be required to provide collection of relevant information of the incidents to enhance the accuracy of investigations and regularization for the vehicles.

Some embodiments described in the present disclosure relate to electronic devices and methods for generation of conclusive consensus reports related to incidents (for example accidents) associated with vehicles, and storage of the reports in a public distributed ledger for application of regulations for the vehicles. The electronic device in the present disclosure achieves generation of a conclusive incident report related to a first incident (for example an accident) associated with a first vehicle (for example an autonomous vehicle). The conclusive incident report may be generated based on receipt of incident reports from a communication device of the first vehicle and a set of communication devices (for example other vehicles or infrastructure sensors) located within a first zonal range of the first vehicle. The electronic device may generate consensus information based on analysis of the received reports to generate the conclusive incident report which may include accurate details of occurrence of the first incident. The conclusive incident report and other received incident reports may be securely stored on a public distributed ledger, such that the required incident reports may be accessed by authorized parties (such as vehicles manufactures, government agencies, insurance companies, or traffic authorities) associated with the distributed ledger.

According to one or more embodiments of the present disclosure, the electronic device may be configured to generate the conclusive incident report by use of a consensus-based approach that may be implemented with help of smart contracts executed on the distributed ledger, where the smart contract may be associated with the communication devices which may authorized to provide the incident reports based on which the disclosed electronic device may generate the consensus information. The incident reports received from the communication devices (i.e. that may lie within the zonal range of the first incident) may correspond to relevant information about the first incident, due to which the electronic device may provide an accurate determination of the consensus and evidences about the first incident. Further, the storage of the incident reports on the distributed ledger may ensure secure and authentic access, as well as utilization, of the report by different parties. Therefore, with the use of the distributed ledger and the incident reports (received from the communication devices) relevant for a particular incident, the electronic device and the method may further provide determination and application of effective regulations for the vehicles (such as autonomous vehicles).

In one or more embodiments, the disclosed electronic device may be configured to receive a first report from a first communication device. The first report may be related to a first incident which may be associated with the first vehicle corresponding to the first communication device. The first vehicle may include, for example, an autonomous vehicle that experiences the first incident, such as occurrence of an accident of the first vehicle with another vehicle. The first report received from the first communication device may include details of the first incident, for example, details such as cause of the accident of the autonomous vehicle with another vehicle or who is responsible for the first incident. The first communication device may be communicatively coupled to the first vehicle and the electronic device. In an example, the first communication device may be, but not limited to, a smartphone of a person present in the first vehicle at a time of the first incident.

The electronic device may be further configured to receive a second report from each of a set of second communication devices different from the first communication device. Examples of the set of second communication devices may include, but are not limited to, a communication device of a second vehicle, a traffic light system, or an image capturing device. The second report may be related to the first incident associated with the first vehicle. For example, the second report may also include details of the first incident collected or provided by the set of second communication devices. Moreover, each of the set of second communication devices may lie within a first zonal range of the first vehicle. The first zonal range may correspond to a geographical area that may define a zone, observable by one or more sensors associated with the first vehicle (and/or the first communication device), in which the set of the second communication devices are said to be in proximity to the first vehicle. This first zonal range may be further refined as desired to obtain satisfactory sensor data. The set of the second communication devices may witness or communicate certain details about the first incident to the electronic device.

Furthermore, the electronic device may be further configured to transmit the first report received from the first communication device and the second report received from one or more of the set of second communication devices to the distributed ledger communicatively coupled to the electronic device. The distributed ledger (for example hyperledger) may be a permissioned public distributed ledger that may store the received first report and the second reports. The distributed ledger may provide access of the stored reports to only authorized parties, such that the details of the first incident may be shared only with relevant parties (for example vehicle manufactures, transport authorities, or an insurance company).

Moreover, the electronic device may be further configured to generate consensus information to validate the first incident, based on a smart contract, the received first report, and the received second reports. The smart contract may be executed on the distributed ledger and may include information (such as rules) regarding agreements between involved parties, such as the first vehicle and the set of communication devices. The consensus information may be generated by use of consensus algorithms to ensure reliability and integrity of the details of the first incident included in the first report and the second report received from the first communication device and the set of second communication devices, respectively.

The electronic device may be further configured to generate a conclusive incident report related to the first incident based on the generated consensus information. The generated conclusive incident report may include accurate and reliable details or evidences of the first incident that may be accessed by the authorized parties from the distributed ledger for various applications, such as, regulation of the vehicles.

Embodiments of the present disclosure are explained with reference to the accompanying drawings.

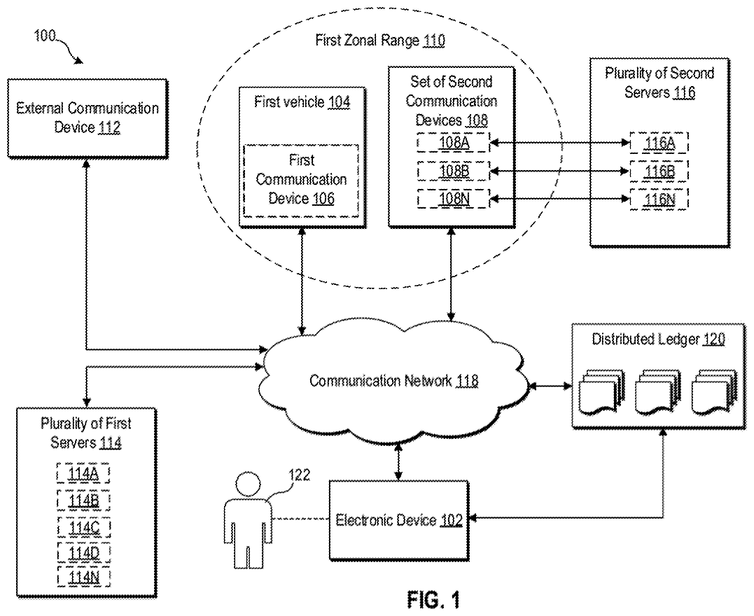

FIG. 1 is a diagram representing an example environment related to application of automobile regulation based on distributed ledger, by an electronic device, arranged in accordance with at least one embodiment described in the present disclosure. With reference to FIG. 1, there is shown an environment 100. The environment 100 may include an electronic device 102. The environment 100 may further include a first vehicle 104. Furthermore, the first vehicle 104 may include a first communication device 106 communicatively coupled to or associated with the first vehicle 104. The environment 100 may further include a set of second communication devices 108 which may include a second communication device 108A, a third communication device 108B, and an Nth communication device 108N as shown in FIG. 1. The first vehicle 104 (including the first communication device 106) and the set of second communication devices 108 may be present in a first zonal range 110. Moreover, the environment 100 may further include an external communication device 112 which may lie outside the first zonal range 110 as shown in FIG. 1.

The environment 100 may further include a plurality of first servers 114 outside the first zonal range 110. The plurality of first servers 114 may include an environmental server 114A, a navigation server 114B, a medical diagnostic server 114C, a transport authority server 114D, and/or a public identification server 114N. Furthermore, the environment 100 may include a plurality of second servers 116. The plurality of second servers 116 may include a second server 116A communicatively coupled to or associated with the second communication device 108A, a third server 116B communicatively coupled to or associated with the third communication device 108B and an Nth server 116N communicatively coupled to or associated with the Nth communication device 108N. The environment 100 may further include a communication network 118. Moreover, the environment 100 may further include a user 122 that may have access to the electronic device 102. The electronic device 102 may be further communicatively coupled to a distributed ledger 120. As shown in FIG. 1, the electronic device 102, the first communication device 106, the set of second communication devices 108, the external communication device 112, the plurality of first servers 114, the plurality of second servers 116, and the distributed ledger 120 may be communicatively coupled to each other, via the communication network 118. It should be noted that number of the set of second communication devices 108, the plurality of first servers 114, and the plurality of second servers 116 shown in FIG. 1, are presented merely as an example. The environment 100 may include any number of the set of second communication devices 108, the plurality of first servers 114, and the plurality of second servers 116, without deviation from the scope of the disclosure. Further, the plurality of first servers 114 are referred as the environmental server 114A, the navigation server 114B, the medical diagnostic server 114C, the transport authority server 114D, and/or the public identification server 114N merely as an example, the plurality of first servers 114 may include other servers which may be useful to provide details or information related to an incident associated with a vehicle.

Examples of the electronic device 102 may include, but are not limited to, a controlling device, a data analyzer system, a computing device, a smartphone, a cellular phone, a mobile phone, a mainframe machine, a server, a computer workstation, a laptop, or a desktop computer.

The electronic device 102 may comprise suitable logic, circuitry, interfaces, and/or code that may be configured to perform one or more operations for generation of a conclusive incident report of a first incident (for example an accident, technical failure associated with the first vehicle, or a traffic jam) which may be associated with the first vehicle 104 or perform one or more operations for the determination of regulations for vehicles including the first vehicle. The electronic device 102 may be configured to control the distributed ledger 120 for the storage and secure management of the conclusive incident report and other incident reports received from the first communication device 106 and the set of second communication devices 108. The electronic device 102 may generate the conclusive incident report and/or determine the regulations for vehicles based on analysis of the incident reports and the control of the distributed ledger 120.

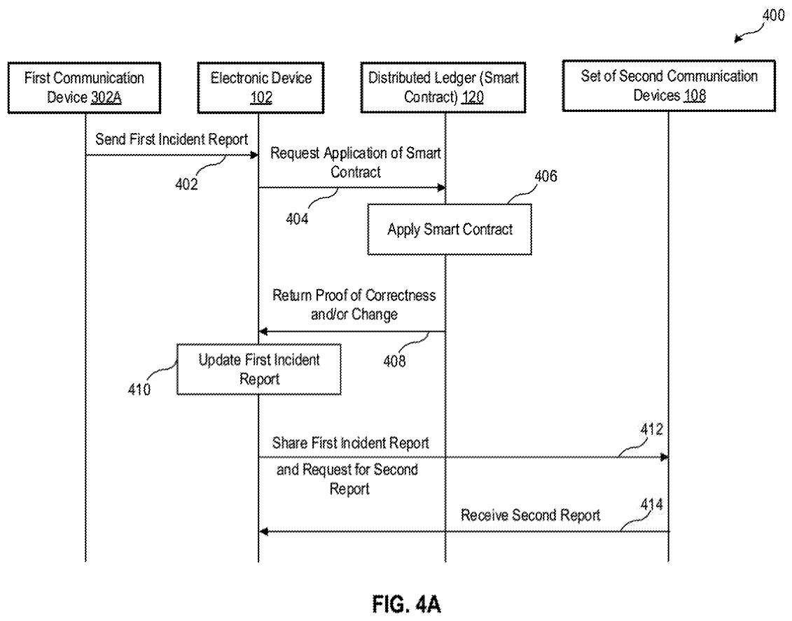

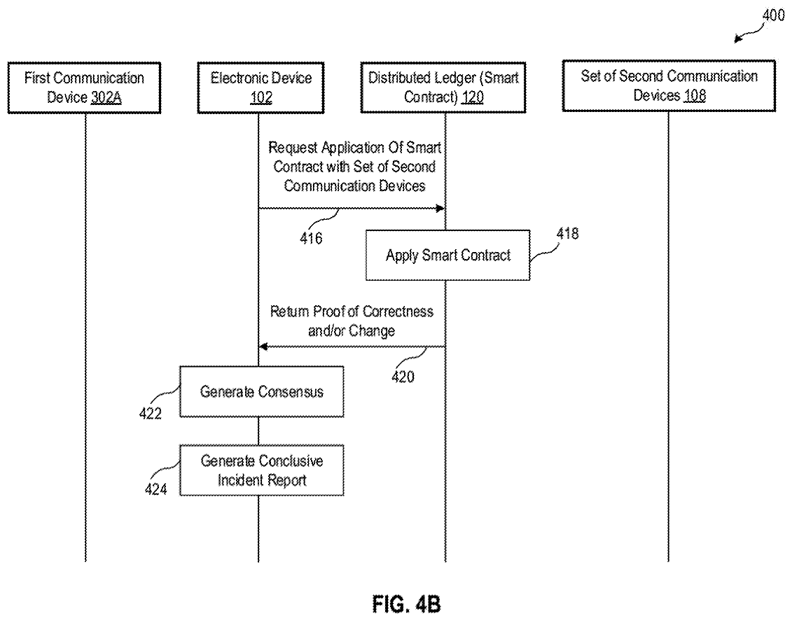

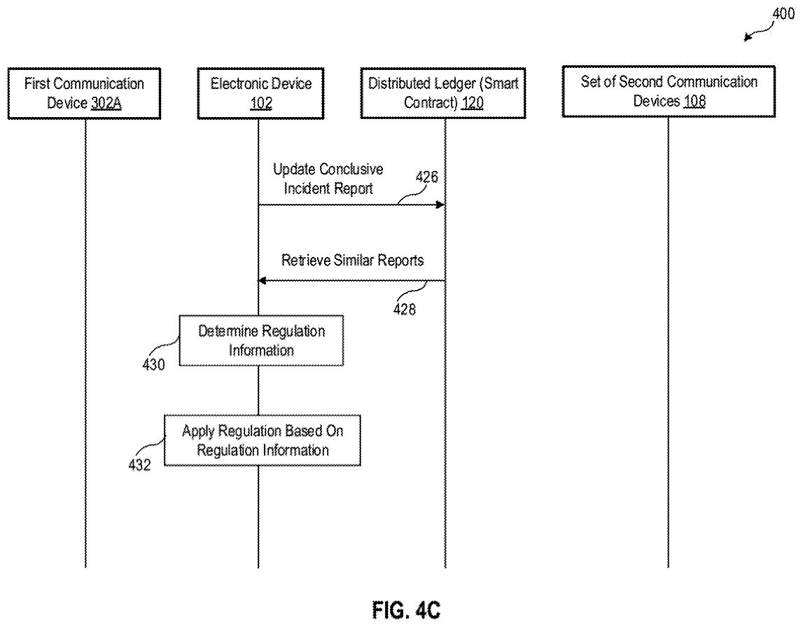

In one or more embodiments, the electronic device 102 may be configured to receive a first report from the first communication device 106 upon occurrence of the first incident associated with the first vehicle 104. The first incident may correspond to, for example, an accident happened with the first vehicle 104 or a technical failure occurred with the first vehicle 104. Details of the first report received from the first communication device 106 is provided, in detail, for example in FIGS. 4A-4C.

In an embodiment, the electronic device 102 may be computing device of a legal or law enforcement department which may be evaluating a legal case associated with the first incident. In another embodiment, the electronic device 102 may be computing device of an insurance company which might be evaluating an insurance claim requested by an owner or occupant of the first vehicle 104 engaged in the first incident. In an embodiment, the electronic device 102 may be a computing device associated with a transport authority involved in an investigation of the first incident to further determine and apply certain regulations for the vehicles. In another embodiment, the electronic device 102 may be a computing device of a medical department which might be evaluating details of the first incident.

The electronic device 102 may be accessed by the user 122 for operating the electronic device 102. The user 122 may be a person who may be investigating any case or evidences related to the first incident occurred with the first vehicle 104. In an example, the user 122 may be, but is not limited to, a legal representative, a law enforcement officer, an authorized insurance executive, a vehicle regulations executive, a transport authority member, a medical department person.

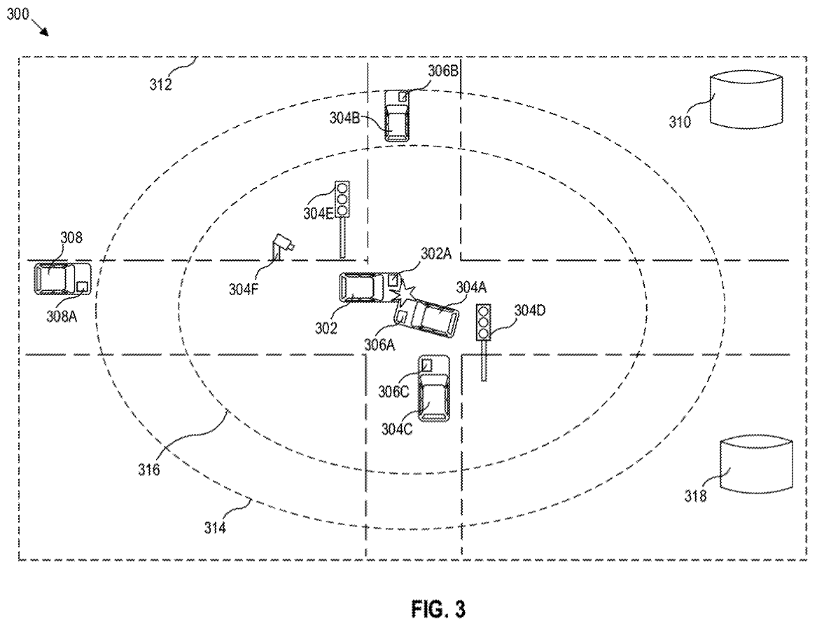

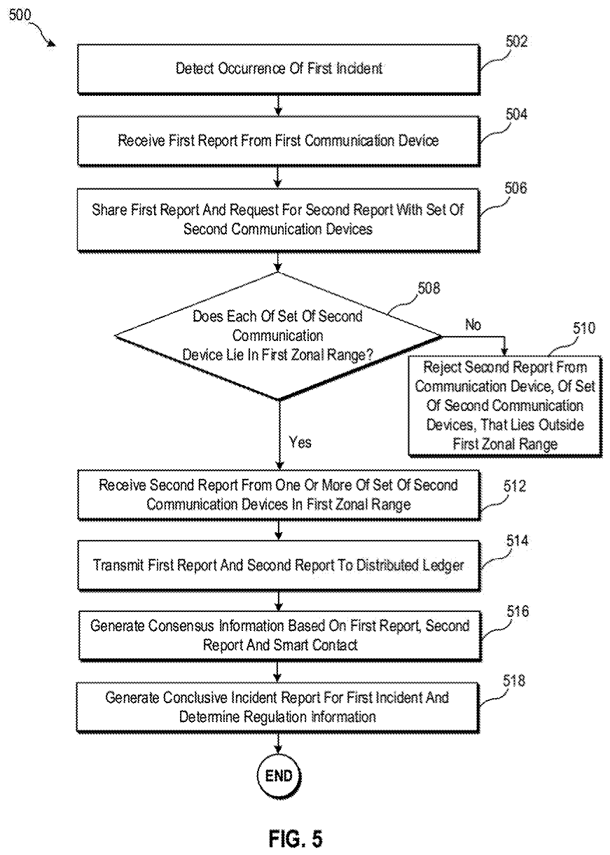

In one or more embodiments, the electronic device 102 may be further configured to receive a second report from each of the set of second communication devices 108 which may lie with the first zonal range 110 of the first vehicle 104. The second report may include details of the first incident associated with the first vehicle 104. The first zonal range 110 is described in detail, for example, in FIG. 3. The electronic device 102 may be configured to receive the second report from the plurality of second servers 116 associated with the set of second communication devices 108. In some embodiments, the electronic device 102 may receive the second report from the plurality of first servers 114. In some embodiments, the electronic device 102 may share the received first report with the set of second communication devices 108. The electronic device 102 may be further configured to accept or reject the received second report based on location of the set of second communication devices 108 or smart contracts associated with the set of second communication devices 108. The acceptance or rejection of the second report is described, in detail, for example, in FIGS. 4A-4C and FIG. 5.

The electronic device 102 may be further configured to transmit the first report received from the first communication device 106 and the second report received from one or more of the set of second communication devices 108 to the distributed ledger 120 communicatively coupled to the electronic device 102. Details of the transmission of the reports related to the first incident to the distributed ledger 120 is described, for example, in FIGS. 4A-4C. The electronic device 102 may be further configured to generate consensus information to validate the first incident, based on smart contracts, the received first report, and the received second reports. The distributed ledger 120 may include smart contract associated with each of the first communication device 106 and the set of second communication devices 108. The generation of the consensus information based on the received reports and the smart contracts is described, for example, in FIGS. 4A-4C.

The electronic device 102 may be further configured to generate the conclusive incident report related to the first incident based on the generated consensus information. The conclusive incident report may include reliable and accurate details or evidences related to the first incident. The conclusive incident report may include details of the first incident as shared by multiple parties, such as the first communication device 106, the set of second communication devices 108, or the plurality of first servers 114. In one or more embodiments, the electronic device 102 may be further configured to determine regulation information for the vehicles based on a plurality of reports (including the conclusive incident report, the first report, and the second reports) stored on the distributed ledger 120. The generation of the conclusive incident report and determination of the regulation information are described, in detail, for example, in FIGS. 4A-4C. The electronic device 102 may be implemented using hardware including a processor, a microprocessor (e.g., to perform or control performance of one or more operations), a field-programmable gate array (FPGA), or an application-specific integrated circuit (ASIC). In some other instances, the electronic device 102 may be implemented using a combination of hardware and software.

Example of the first vehicle 104 may include, but is not limited to, a non-autonomous vehicle, a semi-autonomous vehicle, an autonomous vehicle or an unmanned aerial vehicle. The first vehicle 104 may be a non-autonomous vehicle, a semi-autonomous vehicle, or a fully autonomous vehicle, for example, as defined by National Highway Traffic Safety Administration (NHTSA). Examples of the first vehicle 104 may include, but are not limited to, a two-wheeler vehicle, a three-wheeler vehicle, a four-wheeler vehicle, an unmanned aerial vehicle, a hybrid vehicle, or a vehicle with autonomous drive capability that uses one or more distinct renewable or non-renewable power sources or a vehicle with N number wheels. A vehicle that uses renewable or non-renewable power sources may include a fossil fuel-based vehicle, an electric propulsion-based vehicle, a hydrogen fuel-based vehicle, a solar-powered vehicle, and/or a vehicle powered by other forms of alternative energy sources. The first vehicle 104 may be a system through which a rider may travel from a start point to a destination point. Examples of the two-wheeler vehicle may include, but are not limited to, an electric two-wheeler, an internal combustion engine (ICE)-based two-wheeler, or a hybrid two-wheeler. Similarly, examples of the four-wheeler vehicle may include, but are not limited to, an electric car, an internal combustion engine (ICE)-based car, a fuel-cell based car, a solar powered-car, or a hybrid car. It should be noted that the first vehicle 104 may be any automobile other than the two-wheeler vehicle or four-wheeler vehicles. Description of other types of vehicles are being omitted from the disclosure for the sake of brevity.

The first vehicle 104 may experience the first incident. Examples of the first incident may include, but is not limited to, occurrence of an accident of the first vehicle with another vehicle, occurrence of an accident of the first vehicle with a pedestrian, occurrence of an accident of the first vehicle with any infrastructure (such as a footpath or a traffic light), a technical failure associated with the first vehicle (for example an engine failure within a warrantee period), or a delay of the first vehicle due to a traffic jam.

The first communication device 106 may comprise suitable logic, circuitry, interfaces and/or codes that may be included in the first vehicle 104. The first communication device 106 may be configured to generate the first report based on the details of the first incident and transmit the generated first report to the electronic device 102. In accordance with an embodiment, the first report related to the first incident may include at least one of sensor data (for example, but is not limited to, speed data, engine temperature data, brakes related data, or driver's past driving behavior) associated with the first vehicle 104, one or more images associated with the first incident captured by the first communication device 106, geographical location of the first incident detected by the first communication device 106, or environmental data sensed by the first communication device 106. In some embodiments, the first communication device 106 may receive inputs from a rider of the first vehicle 104 and add the received inputs to the generated first report. The received inputs may include, but is not limited to, a description of cause of the first incident, or information about a set of parties involved in the first incident.

The first vehicle 104 may be communicatively coupled to the first communication device 106. The first communication device 106 may be associated with a user, such as an occupant present in the first vehicle 104. In accordance with an embodiment, the first communication device 106 may be externally mounted on the first vehicle 104 for example a camera to take surrounding images with communication capability. In accordance with another embodiment, the first communication device 106 may have remote access to the first vehicle 104. Examples of the first communication device 106 may include, but is not limited to, a computing device, a smartphone, a cellular phone, a mobile phone, a mainframe machine, a server, a computer workstation, and/or a consumer electronic (CE) device. In some embodiments, the first communication device 106 may be integrated in the first vehicle 104. In such case, examples of the first communication device 106 may include, but are not limited to, an electronic control unit (ECU) of the first vehicle 104, an infotainment system, a vehicle control system, an in-vehicle entertainment system, an automobile Head-up display system, a human-machine interface (HMI), a n instrument cluster, or a Multi-Information Display (MID).

The set of second communication devices 108 may comprise suitable logic, circuitry, interfaces and/or codes that may be configured to generate the second report based on certain details of the first incident associated with the first vehicle 104. The set of second communication devices 108 may be present within the first zonal range 110 of the first vehicle 104. In an embodiment, one of the set of second communication devices 108, for example, the second communication device 108A may be associated with a second vehicle (shown in FIG. 3 as a second vehicle 304A) which may be directly involved in the first incident with the first vehicle 104. In such case, the functionalities of the second communication device 108A associated with the second vehicle may be similar to the first communication device 106 associated with the first vehicle 104. Therefore, the details of the second communication device 108A are omitted from the disclosure for the sake of brevity.

In accordance with an embodiment, the set of second communication devices 108 may further include at least one of, a traffic light system, an image capturing device (for example a closed circuit television (CCTV)), or another electronic device (for example a mobile phone) associated with a person (such as a pedestrian). Such nearby devices (like traffic light systems, CCTVs, mobile phone of nearby people, or RFID systems) may be considered as infrastructure sensors located near the first incident of the first vehicle 104. The set of second communication devices 108 may be located in proximity to the first vehicle 104 at a time of the first incident. In other words, the set of second communication devices 108 may be location within the first zonal range 110 of the first vehicle 104. In some embodiments, the set of second communication devices 108 may include one or more first servers (referred as the plurality of first servers 114) located with a second zonal range which may include the first zonal range 110. The second zonal range (not shown in FIG. 1) may correspond to a larger area associated with the first vehicle 104, for example, a city, a state or a country, which may further include the first zonal range 110, inside which the first incident may have occurred. Details of the first zonal range 110 and the second zonal range are described, in detail, for example, in FIG. 3.

Moreover, each of the set of second communication devices 108 may be configured to send the second report to the electronic device 102 for generation of the conclusive incident report. In some embodiments, the set of second communication devices 108 may receive the first report shared by the first communication device 106, when the set of second communication devices 108 are present in the first zonal range 110. In some embodiments, the set of second communication devices 108 may be configured to receive a request from the first communication device 106 to share the second report with the electronic device 102 in response to the received first report from the first communication device 106. In other embodiment, the set of second communication devices 108 may receive the request from the electronic device 102 to share the second report with the electronic device 102.

The plurality of first servers 114 may comprise suitable logic, circuitry, interfaces and/or codes that may be configured to communicate with the electronic device 102 to provide the second report related to the first incident. The plurality of first servers 114 may be implemented as cloud servers and may execute operations through web applications, cloud applications, Hypertext Transfer Protocol (HTTP) requests, repository operations, file transfer, and the like. Other example implementations of the plurality of first servers 114 may include, but are not limited to, database servers, file servers, web servers, media servers, application servers, mainframe servers, or cloud computing servers. In at least one embodiment, the plurality of first servers 114 may be implemented as plurality of distributed cloud-based resources by use of several technologies that are well known to those ordinarily skilled in the art. A person with ordinary skill in the art will understand that the scope of the disclosure may not be limited to the implementation of the plurality of first servers 114 and electronic device 102 as two separate entities. In certain embodiments, the functionalities of the plurality of first servers 114 can be incorporated in its entirety or at least partially in the electronic device 102, without a departure from the scope of the disclosure.

The plurality of first servers 114 may include the environmental server 114A, the navigation server 114B, the medical diagnostic server 114C, the transport authority server 114D, and/or the public identification server 114N. In accordance with an embodiment, the environmental server 114A of the plurality of first servers 114 may be configured to provide environmental information (such as weather conditions, temperature, pressure, air density, rainfall, and so forth) about the first zonal range 110 and/or the second zonal range 312 in the second report transmitted to the electronic device 102. Further, in an example, the navigation server 114B of the plurality of first servers 114 may be configured to provide navigational information (such as latitude, longitude and elevation of location) of the first incident in the second report. For example, the navigation server 114B may be a Global Positioning System (GPS) server, a Global Navigation Satellite System (GLONASS) server, a BeiDou Navigation Satellite System (BDS) server and the like. In some embodiments, the navigation server 114B may provide current vehicle traffic information or road conditions in the first zonal range 110 at a time of the first incident, in the second report to the electronic device 102. Furthermore, the medical diagnostic server 114C of the plurality of first servers 114 may be configured to provide medical or health diagnostic information about the people (for example driver or occupant of the first vehicle 104, or pedestrian involved in the first incident), in the second report to the electronic device 102. For example, the electronic device 102 may receive health information, such as heart related ailments of the pedestrian who may have met with an accident with the first vehicle 104, from the medical diagnostic server 114C. Further, the transport authority server 114D may be configured to provide information related to the first vehicle 104, the second vehicle, or the occupant of the first vehicle 104 in the second report to the electronic device 102. The information may include, but is not limited to, a validity of a license, past traffic violations, a frequency of accidents in a particular period, a past driving behavior or pattern of the occupant (or driver) of the first vehicle 104 or the second vehicle involved in the first incident. Further, the public identification server 114N of the plurality of first servers 114 may be configured to provide identification information of people (i.e. present in the first zonal range 110 where the first incident occurred) in the second report to the electronic device 102. For example, the electronic device 102 may receive the identification information, such as an image, name, age, and address of the pedestrian who may have met with the accident with the first vehicle 104 from the public identification server 114N.

The plurality of second servers 116 may comprise suitable logic, circuitry, interfaces and/or codes that may be configured to receive the second report from the set of second communication devices 108. The plurality of second servers 116 may be associated with the second communication device 108A. For example, one of the plurality of second servers 116 (such as the second server 116A) may be associated with the second vehicle, such a server of a manufacturing company of the second vehicle or the second communication device 108A. The second server 116A may receive or store sensor data (for example, but not limited to, speed data, engine temperature, or trip data) of the second vehicle. In another example, one of the plurality of second servers 116 (such as the third server 116B) may be a server associated with the third communication device 108B (i.e. CCTV located in the first zonal range 110), where all the captured images or videos are stored in the third server 116B. The third server 116B may correspond to a server maintained by a manufacturer of the third communication device 108B (for example CCTV). In another example, one of the plurality of second servers 116 (such as the Nth server 116N) may be a server where information about the Nth communication device 108N (i.e. traffic lights system located in the first zonal range 110) are stored. The information may include, but not limited to, a working condition of the traffic light system, or a status of the traffic light system at the time of the first incident. The Nth server 116N may correspond to a server maintained by a manufacturer of the Nth communication device 108N (for example traffic light system).

In some embodiments, the plurality of second servers 116 may be configured to transmit the corresponding second report to the electronic device 102 based on a request received from the corresponding set of second communication devices 108 or directly from the electronic device 102. In one or more embodiments, each of the set of second communication devices 108 may receive corresponding second report from individual servers, such as the plurality of second servers 116 and further provide the received second report to the electronic device 102.

In one or more embodiments, the electronic device 102 may be configured to receive the second report from the external communication device 112 that lies outside the first zonal range 110 of the first vehicle 104 at a time of the first incident. Moreover, the electronic device 102 may be configured to reject the second report received from the external communication device 112 based on a determination that the external communication device 112 lies outside the first zonal range 110 of the first vehicle 104 at the time of the first incident. The functionalities of the external communication device 112 may be similar to the set of second communication devices 108. Examples of the external communication device 112 may include, but is not limited to, another vehicle, a traffic light system, or image capturing device, like CCTV. The details of the external communication device 112 are omitted from the disclosure for the sake of brevity.

The communication network 118 may include a communication medium through which the electronic device 102 may communicate with the first communication device 106, the set of second communication devices 108, the external communication device 112, the plurality of first servers 114, the plurality of second servers 116, and the distributed ledger 120. Examples of the communication network 118 may include, but are not limited to, the Internet, a cloud network, a Wireless Fidelity (Wi-Fi) network, a Personal Area Network (PAN), a Local Area Network (LAN), and/or a Metropolitan Area Network (MAN). Various devices in the environment 100 may be configured to connect to the communication network 118, in accordance with various wired and wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), ZigBee, EDGE, IEEE 802.11, light fidelity(Li-Fi), 802.16, IEEE 802.11s, IEEE 802.11g, multi-hop communication, wireless access point (AP), device to device communication, cellular communication protocols, and/or Bluetooth (BT) communication protocols, or a combination thereof.

In an embodiment, one or more of the electronic device 102, the first communication device 106, the set of second communication devices 108, the plurality of first servers 114, the plurality of second servers 116, the external communication device 112, and the distributed ledger 120 may be an application programming interface (API)-enabled device including web applications and/or multiple micro-services. The one or more devices or servers may further include or coupled to an API gateway to perform different operations, for example, but not limited to, authentication of API call requests, authorization of requester, security, routing of API call request to different micro-service, data caching, load balancing, or protocol/format conversion. The one or more API enabled devices or servers may request data (i.e. incident report) or provide data by sending or requesting API calls, through the corresponding API gateways to other API enabled devices or servers.

The distributed ledger 120 may be a decentralized and distributed database system that may maintain or manage an immutable record of data operations. A set of data operations may be grouped together as a block and may be further linked to a previous block of data operations to form a chain of the plurality of blocks. For example, any data such as the first report or the second report may be stored in the distributed ledger 120 in form of the plurality of blocks. All blocks of the data operations may be stored in a decentralized manner, whereby all authorized participants or nodes, such as the first communication device 106 and the set of second communication devices 108 may store or access all the plurality of blocks. In the decentralized approach, each authorized node may provide input (e.g. incident report, evidences, or vote about the first incident) on each stored data or block collected from different nodes.

By way of example, and not limitation, the distributed ledger 120 may be a Hyperledger blockchain, a Corda blockchain, an Ethereum blockchain, an Amazon Quantum Ledger Database (QLDB), a BigChain database (DB) blockchain. In one or more embodiments, the Hyperledger blockchain may be a Hyperledger Burrow blockchain, a Hyperledger Fabric blockchain, a Hyperledger Indy blockchain, a Hyperledger Iroha blockchain, a Hyperledger Sawtooth blockchain.

In some embodiments, the distributed ledger 120 may include an operating system (for example, a Java Virtual Machine (JVM)) which may allow deployment of a smart contract between multiple parties, for example, the first communication device 106, the set of second communication devices 108, the plurality of first servers 114 or the plurality of second servers 116. The smart contract executed on the distributed ledger 120 may be associated with each of the first communication device 106, the one or more of the set of second communication devices 108, the plurality of first servers 114, or the plurality of second servers 116. By way of example, and not limitation, the distributed ledger 120 may be a Hyperledger blockchain that may be configured to execute the smart contract that may enable different operations, for example, storage or retrieval of incident reports, generation of the consensus information, or the generation of the conclusive incident report based on the successful execution of the smart contract. The scope of the disclosure may not be limited to the implementation of the distributed ledger 120 as the Hyperledger blockchain. In some embodiments, other implementations of the distributed ledger 120 (such as the Corda blockchain, the Ethereum blockchain, the Amazon Quantum Ledger Database (QLDB) or the BigChain database (DB) blockchain) may be possible in the present disclosure, without a deviation from the scope of the present disclosure.

Modifications, additions, or omissions may be made to FIG. 1 without departing from the scope of the present disclosure. For example, the environment 100 may include more or fewer elements than those illustrated and described in the present disclosure. For instance, in some embodiments, the environment 100 may include the electronic device 102 but not the plurality of first servers 114 and the plurality of second servers 116. In addition, in some embodiments, the functionality of one of the plurality of first servers 114 or one of the plurality of second servers 116 may be incorporated into the electronic device 102, without a deviation from the scope of the disclosure.

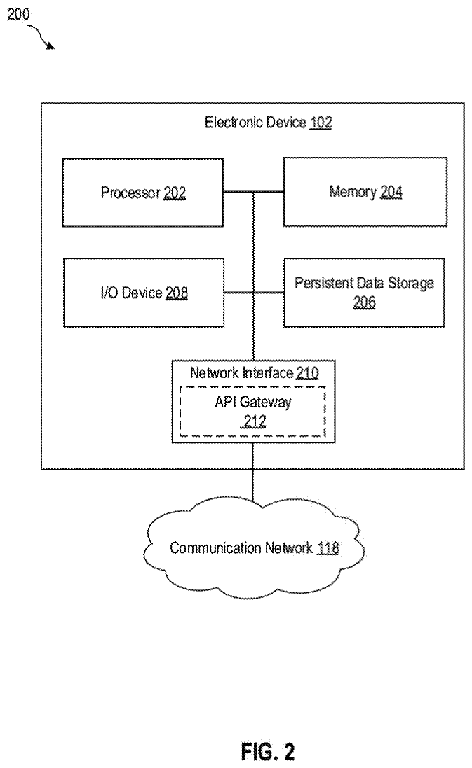

FIG. 2 is a block diagram that illustrates an exemplary electronic device for determination of automobile regulation based on distributed ledger, arranged in accordance with at least one embodiment described in the present disclosure. FIG. 2 is explained in conjunction with elements from FIG. 1. With reference to FIG. 2, there is shown a block diagram 200 of the electronic device 102. The electronic device 102 may include a processor 202, a memory 204, a persistent data storage 206, an input/output (I/O) device 208, and a network interface 210. The network interface 210 may further include an application program interface (API) gateway 212.

The processor 202 may comprise suitable logic, circuitry, and/or interfaces that may be configured to execute program instructions associated with different operations to be executed by the electronic device 102. For example, some of the operations include reception of the first report from the first communication device 106, reception of the second report from each of a set of second communication devices 108, transmission of the first report and the second reports to the distributed ledger 120, generation of the consensus information, generation of the conclusive incident report, or determination of the regulations for the automobiles. The processor 202 may include any suitable special-purpose or general-purpose computer, computing entity, or processing device including various computer hardware or software modules and may be configured to execute instructions stored on any applicable computer-readable storage media. For example, the processor 202 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor in FIG. 2, the processor 202 may include any number of processors configured to, individually or collectively, perform or direct performance of any number of operations of the electronic device 102, as described in the present disclosure. Additionally, one or more of the processors may be present on one or more different electronic devices, such as different servers.

In some embodiments, the processor 202 may be configured to interpret and/or execute program instructions and/or process data stored in the memory 204 and/or the persistent data storage 206. In some embodiments, the processor 202 may fetch program instructions from the persistent data storage 206 and load the program instructions in the memory 204. After the program instructions are loaded into the memory 204, the processor 202 may execute the program instructions. Some of the examples of the processor 202 may be a graphics processing unit (GPU), a central processing unit (CPU), a Reduced Instruction Set Computer (RISC) processor, an application-specific integrated circuit (ASIC) processor, a complex instruction set computer (CISC) processor, a co-processor, and/or a combination thereof.

The memory 204 may comprise suitable logic, circuitry, and/or interfaces that may be configured to store program instructions executable by the processor 202. In certain embodiments, the memory 204 may be configured to store operating systems and associated application-specific information. The memory 204 may include computer-readable storage media for carrying or having computer-executable instructions or data structures stored thereon. Such computer-readable storage media may include any available media that may be accessed by a general-purpose or special-purpose computer, such as the processor 202. By way of example, and not limitation, such computer-readable storage media may include tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store particular program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 202 to perform a certain operation or group of operations associated with the electronic device 102.

The persistent data storage 206 may comprise suitable logic, circuitry, and/or interfaces that may be configured to store program instructions executable by the processor 202, operating systems, and/or application-specific information, such as logs and application-specific databases. The persistent data storage 206 may include computer-readable storage media for carrying or having computer-executable instructions or data structures stored thereon. Such computer-readable storage media may include any available media that may be accessed by a general-purpose or special-purpose computer, such as the processor 202.

By way of example, and not limitation, such computer-readable storage media may include tangible or non-transitory computer-readable storage media including Compact Disc Read-Only Memory (CD-ROM) or other optical disk storage, magnetic disk storage or other magnetic storage devices (e.g., Hard-Disk Drive (HDD)), flash memory devices (e.g., Solid State Drive (SSD), Secure Digital (SD) card, other solid state memory devices), or any other storage medium which may be used to carry or store particular program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 202 to perform a certain operation or group of operations associated with the electronic device 102.

In some embodiments, either of the memory 204, the persistent data storage 206, or combination may store the smart contracts and the consensus information. The processor 202 may fetch software instructions related to the smart contracts to perform different operations of the disclosed electronic device 102. In some embodiments, either of the memory 204, the persistent data storage 206, or combination may store the first report, the second report and the conclusive incident report associated with the first vehicle 104, and the regulation information

The I/O device 208 may include suitable logic, circuitry, interfaces, and/or code that may be configured to receive a user input, for example, from the user 122. For example, the electronic device 102 may receive the user input to initiate an investigation about the first incident of the first vehicle 104. In some embodiments, the user 122 may provide the second report including details of the first incident, via the I/O device 208. The I/O device 208 may be further configured to provide an output in response to the user input. For example, I/O device 208 may receive a request, as the user input, from the user 122 to extract the conclusive incident report from the distributed ledger 120 for regulation of the first vehicle 104. The I/O device 208 may provide the generated consensus information as the output based on the received first report and the second reports about the first incident.

The I/O device 208 may include various input and output devices, which may be configured to communicate with the processor 202 and other components, such as the network interface 210. Examples of the input devices may include, but are not limited to, a touch screen, a keyboard, a mouse, a joystick, and/or a microphone. Examples of the output devices may include, but are not limited to, a display and a speaker.

The network interface 210 may comprise suitable logic, circuitry, interfaces, and/or code that may be configured to establish a communication between the electronic device 102, the first communication device 106, the set of second communication devices 108, the external communication device 112, the plurality of first servers 114, the plurality of second servers 116, and the distributed ledger 120, via the communication network 118.

The network interface 210 may be implemented by use of various known technologies to support wired or wireless communication of the electronic device 102 via the communication network 118. The network interface 210 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, and/or a local buffer.

The network interface 210 may communicate via wireless communication with networks, such as the Internet, an Intranet and/or a wireless network, such as a cellular telephone network, a wireless local area network (LAN) and/or a metropolitan area network (MAN). The wireless communication may use any of a plurality of communication standards, protocols and technologies, such as Global System for Mobile Communications (GSM), Enhanced Data GSM Environment (EDGE), wideband code division multiple access (W-CDMA), Long Term Evolution (LTE), code division multiple access (CDMA), time division multiple access (TDMA), Bluetooth, Wireless Fidelity (Wi-Fi) (such as IEEE 802.11a, IEEE 802.11b, IEEE 802.11g and/or IEEE 802.11n), voice over Internet Protocol (VoIP), light fidelity (Li-Fi), or Wi-MAX.

Moreover, the API gateway 212 of the network interface 210 may be configured to provide a reliable single-entry point for different services (such as micro-services) provided by web applications included in the electronic device 102. In one or more embodiments, one or more of the first communication device 106 of the first vehicle 104, the set of second communication devices 108 (such as the second communication device 108A of the second vehicle), the plurality of first servers 114 and the plurality of second servers 116 may include an API gateway to handle API calls received from other devices or servers. The API call may correspond to store or retrieve data (for example, but not limited to, incident reports, vehicle sensor data, captured images, status of traffic lights). The API gateway 212 may be configured perform various operations, for example, authentication of API calls, authorization of data requester, security, routing of API call to different micro-service, data caching, load balancing, or protocol/format conversion. For example, the API gateway 212 of the electronic device 102 may verify or authorize the nodes such as the first communication device 106 and the set of second communication devices 108 to share the first report or the second report about the first incident, via the network interface 210. It should be noted that the API gateway 212 are shown integrated in the electronic device 102 in FIG. 2. According to one or more embodiments, the API gateway 212 may be communicably coupled with the electronic device 102 and may be considered as separate entities, without any deviation from the scope of the invention.

Modifications, additions, or omissions may be made to the example electronic device 102 without departing from the scope of the present disclosure. For example, in some embodiments, the example electronic device 102 may include any number of other components that may not be explicitly illustrated or described for the sake of brevity.

FIG. 3 illustrates an exemplary scenario to depict a first incident associated with a first vehicle, according to at least one embodiment described in the present disclosure. FIG. 3 is explained in conjunction with elements from FIG. 1 and FIG. 2. With reference to FIG. 3, there is shown a scenario 300. In the scenario 300, there is shown a first vehicle 302 (similar to the first vehicle 104 shown in FIG. 1). The first vehicle 302 may include a first communication device 302A (similar to the first communication device 106 of FIG. 1). There is further shown a second vehicle 304A, a third vehicle 304B and a fourth vehicle 304C, a first traffic light system 304D, a second traffic light system 304E, and a Closed-Circuit Television (CCTV) camera 304F as an image capturing device. Moreover, the second vehicle 304A may include a second communication device 306A which may be similar to the second communication device 108A shown in FIG. 1. The third vehicle 304B may include a communication device 306B, and the fourth vehicle 304C may include a communication device 306C with functionalities similar to the second communication device 306A. The CCTV camera 304F may correspond to the third communication device 108B as shown in FIG. 1. The first traffic light system 304D and the second traffic light system 304E may correspond to the Nth communication device 108N as shown in FIG. 1. The exemplary scenario 300 may further include an external vehicle 308, an external communication device 308A (i.e. similar to the external communication device 112 shown in FIG. 1) in the external vehicle 308, and a public identification server 310 and (i.e. similar to the public identification server 114N of the plurality of first servers 114 shown in FIG. 1). The exemplary scenario 300 may further include an environmental server 318 similar to the environmental server 114A of the plurality of first servers 114 of FIG. 1. The exemplary scenario 300 may further include a second zonal range 312, a first zonal range 314 (i.e. similar to the first zonal range 110 shown in FIG. 1) and a third zonal range 316.

Although in FIG. 3, the first communication device 302A, the second communication device 306A, the communication device 306B, the communication device 306C, and the external communication device 308A are shown integrated in the first vehicle 302, the second vehicle 304A, the third vehicle 304B, the fourth vehicle 304C and the external vehicle 308 respectively, the disclosure is not so limited. Accordingly, in some embodiments, the first communication device 302A, the second communication device 306A, the communication device 306B, the communication device 306C, and the external communication device 308A may be separated from the first vehicle 302, the second vehicle 304A, the third vehicle 304B, the fourth vehicle 304C and the external vehicle 308 respectively, without deviation from scope of the disclosure.

The functions of the first vehicle 302 and the first communication device 302A may be same as the functions of the first vehicle 104 and the first communication device 106 respectively described, for example, in FIG. 1. Therefore, the description of the first vehicle 302 and the first communication device 302A is omitted from the disclosure for the sake of brevity. The second communication device 306A, the communication device 306B, the communication device 306C, the first traffic light system 304D, the second traffic light system 304E, and the CCTV camera 304F are a set of second communication devices, such as the set of second communication devices 108 described in FIG. 1. The CCTV camera 304F shown in FIG. 3, is presently merely as an example. There may be any image capturing device, as the third communication device 108B, for example, a wide-angle camera, 360-degree camera, a camcorder, a digital camera, a night vision camera, or other image capturing systems, to capture images of the first incident.

In an embodiment, the scenario 300 may depict a first incident associated with the first vehicle 302. For example, the first incident may be an accident, such as a collision, between the first vehicle 302 and the second vehicle 304A as shown in FIG. 3. In the scenario 300, the third vehicle 304B, the fourth vehicle 304C, the first traffic light system 304D, the second traffic light system 304E, and the CCTV camera 304F (as the set of second communication devices 108) may be within the first zonal range 314 and may be considered an observer party of the first incident, as shown in FIG. 3. The first zonal range 314 may be a predefined distance (for example in meters(m), Kilometers (Km) or in miles) from the first vehicle 302. The first zonal range 314 may be defined in a manner that the third vehicle 304B, the fourth vehicle 304C, the first traffic light system 304D, the second traffic light system 304E, and the CCTV camera 304F (i.e. being in proximity to the first vehicle 302) may be aware about the first incident or may have correct or sufficient details or evidences about the first incident happened with the first vehicle 302 and the second vehicle 304A. For example, the second communication device 306A of the second vehicle 304A, the communication device 306B of the third vehicle 304B, the communication device 306C of the fourth vehicle 304C or the corresponding occupants of each vehicle may have certain details about the first incident or about the first vehicle 302 such as, but not limited to, a description of cause of the accident, who is the responsible party for the accident, road condition, status of traffic lights, captured images of the first vehicle 302, captured images of the first incident, information about driver of the first vehicle 302 or the second vehicle 304A. In another example, the first traffic light system 304D and/or the second traffic light system 304E (as one of the set of second communication devices 108) may provide a status of lights at a time of the first incident. In another example, the CCTV camera 304F (as one of the set of second communication devices 108) may provide one or more images of the first incident or the first vehicle 302 or the second vehicle 304A just before the occurrence of the first incident. Such images may assist the electronic device 102 to identify the cause of accident or correct evidence to identify the fault. In an embodiment, the first zonal range 314 may include, but is not limited to, a road, a street, a crossing, a landmark, a zone, or a physical area. The first zonal range 314 may be defined based on a geo-location of the first vehicle 302 and presence of the set of second communication devices 108 within a particular distance or radius from the first vehicle 302. For example, in case a number of the set of second communication devices 108 are limited (say only one) at the time of the first incident, the first communication device 302A of the first vehicle 302 may increase the scope or distance covered by the first zonal range 314 to target more number of the set of second communication devices 108 which may provide sufficient or relevant details about the first incident. In some embodiments, the electronic device 102 may be configured to define the first zonal range 314 based on the geo-location of the first vehicle 302 and geo-locations of the set of second communication devices 108 close to the first vehicle 302. The electronic device 102 may control the memory 204 to store current geo-locations of the set of second communication devices 108 and the first vehicle 302. In some embodiments, the electronic device 102 may periodically receive the current geo-locations of each of the set of second communication devices 108 and the external vehicle 308 from the corresponding vehicle or device.

As shown in FIG. 3, the environmental server 318 and the public identification server 310 are shown in the second zonal range 312. In an example, the second zonal range 312 may include, but is not limited to, a town, a city, or a state, and the second zonal range 312 may include the first zonal range 314. In an embodiment, the environmental server 318 may provide information about environmental conditions (like temperature, rainfall amount, a level of fog/smog, a level of dust, or wind speed/direction) at the first zonal range 314 at a time of the first incident. The environmental server 318 may not be inside the first zonal range 314, but may be associated with the second zonal range 312 which may include the first zonal range 314. Similarly, the public identification server 310 may provide information about the driver (for example driving behavior or past accident summary) of the first vehicle 302 or the second vehicle 304A involved in the first incident. Furthermore, as shown in FIG. 3, the first zonal range 314 may include the third zonal range 316. The third zonal range 316 may correspond to an area (with respect to the first vehicle 302) beyond which any communication device (or vehicle) of the set of second communication devices 108 may be considered to be moving out of the first zonal range 314. For example, the third vehicle 304B may be considered to be exiting the first zonal range 314 as shown in FIG. 3.

Further, as shown in FIG. 3, The external vehicle 308 lies outside the first zonal range 314. The external vehicle 308 and the corresponding external communication device 308A may not be considered an important party, by the first vehicle 302 or the electronic device 102, to provide the correct details or evidences for the first incident. In other words, the electronic device 102 may consider the details (i.e. second report) provided by the external communication device of the 308A vehicle 308 as irrelevant. Therefore, based on the consideration of the first zonal range 314, the disclosed electronic device 102 may only receive or select the relevant information about the first incident, received from the relevant parties (i.e. the second vehicle 304A, the third vehicle 304B, the fourth vehicle 304C, the first traffic light system 304D, the second traffic light system 304E, and the CCTV camera 304F) which may in proximity to the first vehicle 302 at the time of the occurrence of the first incident.

In an embodiment, the first communication device 302A of the first vehicle 302 may provide the first report to the electronic device 102 (not shown in FIG. 3). The other communication devices, (such as the second communication device 306A of the second vehicle 304A, the communication device 306B of the third vehicle 304B and the communication device 306C of the fourth vehicle 304C may provide the second report to the electronic device 102. Furthermore, the first traffic light system 304D, the second traffic light system 304E and the CCTV camera 304F may also provide the respective second reports to the electronic device 102 to perform the investigation and generate the conclusive incident report for the first incident, as described, in detail, for example, in FIGS. 4A-4C.

FIGS. 4A-4C collectively illustrates a sequence diagram to depict determination of automobile regulation based on distributed ledger, in accordance with an embodiment of the disclosure. FIG. 4 is explained in conjunction with elements from FIG. 1, FIG. 2 and FIG. 3. With reference to FIG. 4, there is shown a sequence diagram 400 which illustrates a sequence of operations from 402 to 432. The sequence of operations may be executed by various elements of the environment 100, such as, but not limited to, by the first communication device 302A, the electronic device 102, the distributed ledger 120 and the set of second communication devices 108.

At 402, the first communication device 302A may send the first report to the electronic device 102. The processor 202 of the electronic device 102 may be configured to receive the first report from the first communication device 302A. The first communication device 302A may be associated with the first vehicle 302 as shown in FIG. 3. In an example, the first vehicle 302 may be an autonomous vehicle. In an exemplary scenario, the first vehicle 302 (for example, an autonomous car) may experience the first incident, such as accident of the first vehicle 302 with another vehicle, such as the second vehicle 304A, as shown in FIG. 3. In an example, the accident between the first vehicle 302 and the second vehicle 304A may be due to, but is not limited to, a technical fault of the first vehicle 302, a technical fault of the second vehicle 304A, poor road conditions, low visibility due to bad weather, loss of balance of the first vehicle 302 or the second vehicle 304A due to any obstacle on the road, faulty traffic light system, human error associated with a person using the first vehicle 302 or the second vehicle 304A, and so forth. In an embodiment, the first report may be received by the electronic device 102 once the first incident has occurred.

The first report may include information related to the first incident, such as sensor data associated with the first vehicle 302. Examples of sensors of the first vehicle 104 to collect the sensor data may include, but are not limited to, an image sensor, a speed sensor, a temperature sensor, a location sensor, a fuel sensor, a brake sensor, or an acceleration sensor. For example, the image sensor (i.e. camera) may be utilized in the first vehicle 302 to capture images of the surrounding of the first vehicle 302 or location of the first incident. Based on the captured images, the first communication device 302A may identify nearby vehicles, pedestrians, traffic signs, road markings, calculate distance between the first vehicle 302 and objects such as pedestrians, determine status of the detected objects such as a moving object or a stationary object, surroundings of the first vehicle 302, and so forth. In another example, the speed sensor of the first vehicle 302 may provide speed of the first vehicle 302 just before the occurrence of the first incident. The sensor data collected by the sensors of the first vehicle 302 may be provided by the first communication device 302A in the first report. Moreover, the first report may include one or more images associated with the first incident. In an example, the first report may include images showing a scene of the first incident. The first report may also include geographical location and navigation information (for example close traffic jams or locations) of the first incident, such as name of site of the first incident as well as geographical coordinates of the geographical location. The first report may also include environmental data, such as temperature, humidity, visibility and time of the day during the first incident. The first communication device 302A may receive the environment data from the environmental server 318 or may utilize in-built sensors to determine the environment data. Further, the first report may include description of cause of the first incident. Examples of the cause of the first incident may include, but are not limited to, violation of traffic rules by the first vehicle 302, technical fault of the first vehicle 302 (like brake fail or high engine temperature), violation of the traffic rules by a pedestrian, poor road infrastructure, or faulty nearby traffic light system. Furthermore, the first report may include information about a set of parties involved in the first incident or responsible for the first incident, such as manufacturer details of the first vehicle 302 in case of technical failure of internal part or component of the first vehicle 302, identification of a person who may be driving the first vehicle 302 or the second vehicle 304A, identification of a pedestrian involved in an accident, or health information (for example mentally or visually challenge) of the pedestrian involved in the accident and the like.

In some embodiments, the electronic device 102 may be configured to send a request to the first communication device 302A to send the first report. The electronic device 102 may be a device involved or associated with an investigation of the first incident. For example, the electronic device 102 may a device of an investigation officer (like the user 122) of the first incident. In an embodiment, the electronic device 102 may be configured to receive the first report related to the first incident (for example, details of the accident experienced by the first vehicle 302) from the first communication device 302A of the first vehicle 302, via the application programming interface (API). The API may provide an interface or a communication protocol that may be utilized by the first communication device 302A for communication of the first report, via the communication network 118. The electronic device 102 may include (or coupled with) the API gateway 212 that may be configured receive the first report in form of an API call request from the first communication device 302A. The API gateway 212 of the electronic device 102 may be configured to allow or reject the API call request from the nodes, such as the first communication device 302A. The API call request may be rejected based on failure of authorization of the first communication device 302A. In some embodiments, rather than receipt of the first report, the electronic device 102 may receive an identifier related to the first report (say report about a past incident) which may be stored in the memory 204 or the persistent data storage 206 of the electronic device 102. In such case, the electronic device 102 may retrieve or select the first report from the memory 204 or the persistent data storage 206 based on the received identifier received from the first communication device 302A.

At 404, the electronic device 102 may be configured to request for the application of the smart contract associated therewith from the distributed ledger 120. For example, the distributed ledger 120 may be a public decentralized ledger where information (for example the first report) from multiple parties (such as the first communication device 302A) may be received and stored. The multiple parties may create or share false/malicious information (say about the first incident) on the distributed ledger 120. Thus, the smart contract may be executed or applied on the distributed ledger 120 to allow sharing of only secure and reliable information by authorized parties. The smart contract may be a set of software codes that include protocols or rules to digitally facilitate, verify and authorize information sharing in the distributed ledger 120. For example, the request for the smart contract may include identification or authorization of the first communication device 302A that shared the first report, identification of the first report, or validation of the first report, for example, based on date and time of creation of the first report. In some embodiments, the electronic device 102 may request the smart contract from the distributed ledger 120 and authorize the first communication device 302A of the first vehicle 302 to receive or accept the first report from the first communication device 302A. The electronic device 102 may request the smart contract which may be associated with the first communication device 302A and further validate the first communication device 302A and the received first report based on the associated smart contract. In an embodiment, the electronic device 102 may validate a format of the received first report based on certain rules set in the smart contract for the format of the first report about the first incident (for example an accident).

At 406, the distributed ledger 120 may apply the smart contract to validate the first report received by the electronic device 102. The smart contract may validate the first report by ensuring that the first report conforms to agreed policies between the parties (for example between the first communication device 302A and the electronic device 102). The smart contract may further verify authentication of the first communication device 302A on the distributed ledger 120. The smart contract may also validate access of the first communication device 302A to execute the smart contract. Moreover, the access of the distributed ledger 120 by the electronic device 102 may be rejected if the validation of the first report or the first communication device 302A fails by the execution of the smart contract on the distributed ledger 120. In accordance with an embodiment, errors that may cause failure of the validation of the first report or the first communication device 302A may be incorrect format followed in the first report, unverifiable signature in the smart contract, duplicate reports received in a short time frame from the first communication device 302A. The validation of the smart contract may ensure integrity of the information (like the first report) shared on the distributed ledger 120.

At 408, the distributed ledger 120 may be configured to return a proof of correctness of the smart contract and/or any change that may have been required in the first report. The proof of correctness may be associated with correct application of the smart contract at step 406. The proof of correctness may ensure that the smart contract is successfully applied with respect to the first report at step 406. The proof of correctness may be returned to the electronic device 102 after successful application of the smart contract on the distributed ledger 120. The distributed ledger 120 may also return the change that may be required in the first report due to the applied smart contract on the received the first report. For example, the first report may require some changes in terms of format, authentic information, missing information as per the policies set in the smart contract.

At 410, the first report may be updated in the electronic device 102 based the proof of correctness and the change received from the distributed ledger 120. In some embodiments, the electronic device 102 may request the first communication device 302A to update the first report based on the changes received from the distributed ledger 120. In some embodiments, the electronic device 102 may receive the updated smart contract corresponding to the first communication device 302A or a smart contract associated with the electronic device 102, from the distributed ledger 120. In such case, the electronic device 102 may update the first report or request the first communication device 302A to update the first report based on the updated rules or policies in the smart contract.

At 412, the electronic device 102 may be configured to share the first report (i.e. validated based on the smart contract on the distributed ledger 120) with the set of second communication devices 108 and may request the second report from the set of second communication devices 108 for the first incident indicated in the first report. In accordance with an embodiment, the processor 202 of the electronic device 102 may be configured to transmit or broadcast the first report related to the first incident to the set of second communication devices. 108 (for example the second communication device 306A of the second vehicle 304A, the communication device 306B of the third vehicle 304B, the communication device 306C of the fourth vehicle 304C, the first traffic light system 304D, the second traffic light system 304E or the CCTV camera 304F shown in FIG. 3). The electronic device 102 may be configured to share the validated first report with the set of second communication devices 108 that may be present in the first zonal range 314 at the time of occurrence of the first incident. The electronic device 102 may further be configured to share the first report with the set of second communication devices 108 that may be present in between the first zonal range 314 and the third zonal range 316. The set of second communication devices 108 (for example the communication device 306B of the third vehicle 304B as shown in FIG. 3) that may be present between the first zonal range 314 and the third zonal range 316 may be considered moving towards exit of the first zonal range 314. The electronic device 102 may consider such communication device (i.e. which were earlier in the first zonal range 314) to receive the first report, and further provide the second report about the first incident. In one or more embodiments, the processor 202 of the electronic device 102 may be configured to transmit a request along with the first report to the set of second communication devices 108 to share the second report in response to the receipt of the first report from the first communication device 302A.

At 414, the processor 202 of the electronic device 102 may receive the second report from each of the set of second communication devices 108. The electronic device 102 may receive the second report based on the transmitted request at step 412. In accordance with an embodiment, the processor 202 of the electronic device 102 may utilize the API to communicate with the set of second communication devices 108 to receive the second report.

In accordance with an embodiment, the set of second communication devices 108 may include at least one of communication device of another vehicle (for example, the second communication device 306A of the second vehicle 304A, the communication device 306B of the third vehicle 304B or the communication device 306C of the fourth vehicle 304C shown in FIG. 3), a traffic light system (for example, the first traffic light system 304D and the second traffic light system 304E shown in FIG. 3), an image capturing device (for example, the CCTV camera 304F shown in FIG. 3), or another electronic device (for example a mobile phone) associated with a person (for example nearby pedestrian (not shown in FIG. 3). Such type of the set of second communication devices 108 may lie within the first zonal range 314 of the first vehicle 302 and may provide details of the first incident in the second report. In some embodiments, the electronic device 102 may receive the second report from one or more of the plurality of first servers 114 (for example, the public identification server 310 and the environmental server 318 shown in FIG. 3) located with the second zonal range which includes the first zonal range. Such plurality of first servers 114 may also provide details about the first incident (for example weather/environmental condition about the location of the first incident or information about an occupant of the first vehicle 302 or the second vehicle 304A as described, for example, in FIG. 1). In some embodiments, the processor 202 of the electronic device 102 may further receive the second report from the plurality of second servers 116 associated with the set of second communication devices 108. The plurality of second servers 116 may regularly store the data associated with respective communication device of the set of second communication devices 108 as described, for example, in FIG. 1.

In accordance with an embodiment, the second report may include details of the first incident (for example an accident). The second report may be acquired from one or more of the set of second communication devices 108 to ensure that the details provided by the first vehicle 302 in the first report is accurate or not. In one or more embodiments, certain details provided in the first report and the second report about the first incident may overlap. In an example, details in the first report shared by the first communication device 302A (associated with the first vehicle 104) may specify that “the second vehicle 304A exceeded a speed limit”. However, details in the second report provided by the second communication device 306A (associated with the second vehicle 304A), the communication device 306B (associated with the third vehicle 304B), the first traffic light system 304D and the CCTV camera 304F may specify that “the first vehicle 104 exceeded the speed limit” and/or “crossed the red light”. The same details of the first incident that may be provided by a majority of communication devices of the set of second communication devices 108 may be considered to be accurate details of the first incident. Therefore, to derive accuracy of the details or cause of the first incident, the first report and the second report may be required from the multiple communication device within the same zonal range such as the first zonal range 314 of the first incident. Due to consideration of the details or evidences provided by multiple parties (vehicles or infrastructure sensors), the disclosed electronic device 102 may take accurate decision or perform accurate investigations, and further avoid biased evidences or decision (i.e. reports) provided by any individual party. In another example, the first report and the second report may indicate that environmental condition at the time of first incident was “raining with low visibility”. In such case, the electronic device 102 may check the second report received from the environmental server 318 to identify the environmental condition at the location of the first incident at the time of the first incident.

In accordance with an embodiment, the first report and the second report may include at least one of public information and private information associated with the first incident. Examples of the public information may include, but are not limited to, location of the first incident, a time stamp (i.e. date-time) associated with the first incident, an identification number associated with the first incident (i.e. incident ID), geographical coordinates of the first incident, or vehicle registration number of the involved vehicles (i.e. first vehicle 302). Examples of the private information may include, but are not limited to, one or more images associated with the first incident, description of cause of the first incident, manufacturer details of the parties involved in the first incident, responsible vehicle or person for the first incident, health details of the pedestrian involved in the first incident, public identification information of the pedestrian involved in the first incident, or past driving behavior or accident records of the involved vehicle or person.

At 416, the electronic device 102 may request for application of a smart contract associated with each of the set of second communication devices 108 on the distributed ledger 120. The smart contract between the electronic device 102 and the set of second communication devices 108 may include defined set of software codes that includes protocols or rules to digitally facilitate, verify and authorize information or the reports shared between the electronic device 102 and the set of second communication devices 108. In an example, the smart contract between the electronic device 102 and the set of second communication devices 108 may include, but is not limited to digital signatures of the electronic device 102 and each of the set of second communication devices 108, authorization information of the electronic device 102 and each of the set of second communication devices 108, validity of the smart contract, predefined format of the second report, and so forth. The electronic device 102 may be further configured to provide the second report received from the set of second communication devices 108 to the distributed ledger 120 along with the request sent for the application of the smart contract. In some embodiments, the electronic device 102 may be configured to authorize each of the set of second communication devices 108 based on the associated smart contract, stored on the distributed ledger 120 or stored internally in the electronic device 102.

At 418, the distributed ledger 120 may be configured to apply the smart contract to validate the receipt of the second report by the electronic device 102. The smart contract may validate the request received from the electronic device 102 (step 416) or the included second report in the request by ensuring that the request conforms to agreed policies between the electronic device 102 and the set of second communication devices 108. The smart contract on the distributed ledger 120 may further verify authentication of the electronic device 102, and the set of second communication devices 108.

In accordance with an embodiment, the processor 202 of the electronic device 102 may be configured control the distributed ledger 120 to validate the authorization of each of the set of second communication devices 108 based on the smart contract associated with each of the set of second communication devices. The authorization of each of the set of second communication devices 108 may depend upon various parameters, for example, validation information of the smart contract of each of the set of second communication devices 108 and so forth. In an example, the processor 202 may validate an authorization of the second communication device 306A (associated with the second vehicle 304A) based on the smart contract with the second communication device 306A to accept the second report received from the second communication device 306A. The processor 202 may further select or reject one or more of set of second communication devices 108 based on the validation. The selection of the relevant communication devices (from the set of second communication devices 108) based on the authorization or validation, may further allow sharing of limited and relevant information (i.e. second report) related to the first incident.

In accordance with an embodiment, the processor 202 may be configured to reject the second report received from a communication device of the set of second communication devices 108 based on unsuccessful validation, where the communication device may be different from the selected one or more of the set of second communication device 108 and may not be registered with the distributed ledger 120. The processor 202 of the electronic device 102 may reject the second report received from the communication device due to failed validation. The validation of the communication device of the set of second communication devices 108 may fail due to, for example, expiration of the smart contract of the second communication device or a frequency of sending incorrect or wrong evidences about past incidents is high. In some embodiments, the processor 202 may detect false information in the second report received from one of the set of second communication devices 108 and accordingly reject such detected false report. The processor 202 may detect the false information based on validation of such information from data stored in the distributed ledger 120 or in the plurality of first servers 114 or the plurality of second servers 116.

In accordance with an embodiment, the processor 202 may be configured to receive the second report (i.e. related to the first incident) from the external communication device 308A (associated with the external vehicle 308 as shown in FIG. 3). The external communication device 308A may lie outside the first zonal range 314 of the first vehicle 302 at the time of the first incident as shown in FIG. 3. For example, the external communication device 308A (associated with the external vehicle 308) may share the second report with the electronic device 102, even though the external vehicle 308 is outside the first zonal range 314. The external vehicle 308 may be entering the first zonal range 314, thus, may have recorded the first incident from a distance or may be aware about the first incident or known to an occupant associated with the second vehicle 304A or the first vehicle 302. The processor 202 may be further configured to reject the second report received from the external communication device 308A based on a determination that the external communication device 308A lies outside the defined first zonal range 314 of the first vehicle 302 at the time of the first incident. The processor 202 may reject the second report from the external communication device 308A as the second report received from the external communication device 308A may be irrelevant for the generation of consensus for the regulation of the first vehicle 302.

At 420, the distributed ledger 120 may be configured to return the proof of correctness of the smart contract between the first communication device 302A and the set of second communication devices 108 within the first zonal range 314, and/or return any change that may have been required in a particular second report. The proof of correctness may be associated with correct application of the smart contract between the first communication device 302A and the set of second communication devices 108 at step 418. The proof of correctness may be returned to the electronic device 102 after successful application of the smart contract between the first communication device 302A and the set of second communication devices 108 or on the received second reports. The distributed ledger 120 may also return the change that may be required in one or more of the second reports due to the applied smart contract on the received second report. For example, the second report from one of the set of second communication devices 108 may require some changes in terms of format, authentic information, or missing information as per the policies set in the corresponding smart contract.

The processor 202 of the electronic device 102 may be configured to transmit the first report received from the first communication device 302A and the second report received from one or more of the set of second communication devices 108 to the distributed ledger 120, that may be communicatively coupled to the electronic device 102. The validated first report from the first communication device 302A and the validated second report from the one or more of the set of second communication devices 108 may be transmitted to the distributed ledger 120 for secure storage.

At 422, the processor 202 of the electronic device 102 may be further configured to generate the consensus information based on the successful application of the smart contract, the received first report, and the received second reports stored in the distributed ledger 120. The consensus information may be utilized to validate and/or investigate the first incident associated with the first vehicle 302 (for example an autonomous vehicle). The details included in the received first report and/or the second reports may be confirmed for correctness by using consensus of all the involved parties, such as the first communication device 302A and each of the set of second communication devices 108.

The consensus information may provide information related to common details in the first report and the second report that majority of communication devices from the first communication device 106 and the set of second communication devices 108 agree upon. The consensus information may be generated by use of consensus algorithms. Example of the consensus algorithms may include, but is not limited to, a practical Byzantine fault tolerance (PBFT)algorithm, a proof-of-stake (PoS) algorithm and a delegated proof-of-stake (DPoS) algorithm.

In an example, the first report and the second report may include details of the cause of an accident experienced by the first vehicle 104. The first report may include detail such as “traffic signal light was green when the accident occurred”. However, each of the second report from each of the set of second communication devices 108 may include detail such as “traffic signal light was red when the accident occurred” related to the accident experienced by the first vehicle 104. Thus, a majority of communication devices from the first communication device 106 and the set of second communication devices 108 agree with the information “traffic signal light was red when the accident occurred”. Therefore, the consensus information may include the detail related to the accident as “traffic signal light was red when the accident occurred”, even though the first communication device 106 of the first vehicle 104 stated otherwise. The generation of the consensus information may allow determination of accurate details of the first incident associated with the first vehicle 104.

In another example, the details provided in the first report by the first communication device 302A associated with first vehicle 302 may include “a first car caused the accident at road crossing due to a brake failure, number of people injured were four and traffic signal at the road crossing was green”. However, the details provided in the second report, by another communication device (for example the second communication device 306A) in the first zonal range 314, may include “a first car caused the accident at road crossing due to a brake failure, number of people injured were six and traffic signal at the road crossing was green”. The first vehicle 302 and the second vehicle 304A which may be directly involved in the first incident may be considered as actor nodes who may be involved in the first incident. Similarly, the details provided in the second report, sent by other communication devices (for example, the communication device 306B of the third vehicle 304B and the communication device 306C of the fourth vehicle 304C in the first zonal range 314), may indicate “a first car caused the accident at the road crossing due to a technical failure, number of people injured were four and traffic signal at the road crossing was green”. Similarly, the details received from the first traffic light system 304D may indicate that the status of the traffic light is “green” at the time of the first incident. In such case, the third vehicle 304B, the fourth vehicle 304C, the first traffic light system 304D may be considered as observer nodes of the first incident, different from the actor nodes (i.e. first communication device 302A of the first vehicle 302 and the second communication device 306A of the second vehicle 304A).

The processor 202 of the electronic device 102 may be configured to analyze the details included in the first report and each of the second reports to generate the consensus information. For example, based on the analysis of the first report and the second reports, the electronic device 102 may determine that the common details were received from a majority of the communication devices or the details received from the first communication device 302A, the communication device 306B, the communication device 306C, and the first traffic light system 304D matches substantially. Therefore, the second report received from the second communication device may not be considered to be accurate. The consensus obtained from the first communication device 302A, the communication device 306B, and the communication device 306C may be considered to deduce that the accurate details of the accident related to the first vehicle 302 are “a first car caused the accident at the road crossing due to a technical failure, number of people injured were four and traffic signal of the road crossing was green”. Such obtained consensus obtained from the set of second communication devices 108 and the first vehicle 302 may be considered as the consensus information generated by the disclosed electronic device 102.

In another example, based on the received first report, the electronic device 102 may broadcast the first report to the set of second communication devices 108 (i.e. either vehicles or infrastructure sensors present in the first zonal range 314) to vote for consensus for the first incident indicated by the first report. The electronic device 102 may further receive multiple votes in the second report from the set of second communication devices 108, and may further generate the consensus information based on the received votes. Based on the analysis of the received votes, the electronic device 102 may determine that where majority of votes agree or disagree with the first report sent by the first vehicle 302. In some embodiments, based on the reports or the votes, the electronic device 102 may determine the cause of the first incident or any vehicle/person/situation responsible for the first incident as the consensus information.

At 424, the processor 202 of the electronic device 102 may be configured to generate the conclusive incident report related to the first incident based on the generated consensus information. The conclusive incident report may include the accurate details of the first incident related to the first vehicle, such as the first vehicle 302 shown in FIG. 3. The conclusive incident report may include, but is not limited to, the generated consensus information or conclusive evidences (for example important information extracted from the first report or the second reports) of the first incident. In some embodiments, the conclusive incident report may include both the private information and the public information related to the first incident. The generated conclusive incident report may be used by an investigation officer or department investigating the first incident.

At 426, the processor 202 of the electronic device 102 may update the distributed ledger 120 with the generated conclusive incident report. The distributed ledger 120 may securely store the information such as the conclusive incident report of the first incident in form of the chain of blocks. In accordance with an embodiment, the distributed ledger 120 may also store plurality of reports, such as the first report and the second report to keep track of all the information related to the first incident.

In an exemplary scenario, the CCTV camera, such as the CCTV camera 304F of FIG. 3 may record information such as movements of the pedestrians, the vehicles (such as the non-autonomous vehicles, the semi-autonomous vehicles and the autonomous vehicles) present in a field-of-view (FOV) of the CCTV camera 304F. The recorded information may be split and stored in the distributed ledger 120 as the private information and the public information. For example, an originally recorded video of a scene comprising the pedestrians and the vehicles may be stored as the private information in the distributed ledger 120, whereas an encrypted content (for example, by use of a hash) of the original recorded video may be stored as the public information in the distributed ledger 120. The hash may be generated by use of conventional hash algorithms such as, for example, secure hash algorithm (SHA) 256, MDS, Keccak 256, and so forth.

Example of the public information and the private information stored in the distributed ledger 120 are presented in Table 1, as follows:

TABLE 1
Public information and private information in the distributed ledger

| | | |
|---|---|---|
| Public information | Timestamp | 1567666836 |
| | First Incident identification (ID) | 753D23963W2 |
| | Unique first vehicle ID | 1X5G34873JA |
| | Latitude | 37.379493 |
| | Longitude | −121.9907396 |
| Private information | Images of scene | IMAGE |

The private information as shown in the Table 1 may be stored with the hash in the distributed ledger 120. The generated hash may be a random alpha numeric code, for example, “4742b2b6563b92ed635b3aab63f5d 02f4af8931c80b7d349ece5355af48263cf”. The electronic device 102 may transmit the conclusive incident report including the public information and the private information with the hash in the distributed ledger 120. The public information may be shared with any authorized party or an authorized node in the distributed ledger 120. For example, the public information may be shared with the set of second communication devices 108 authorized with the distributed ledger 120. On the other hand, the private information may only be shared with selected authorized parties that may be eligible for sharing of the private information. In an example, the private information may include fault details of a vehicle associated with the first incident. This private information may only be shared with a manufacturer of the vehicle, whereas other details such as location and time stamp related to the first incident may be shared with other authorized nodes (for example the set of second communication devices 108) in the distributed ledger 120. The distributed ledger 120 may be configured to store the incident report in a secure manner based on the hash, and may further avoid vulnerability issues with relevant or important information related to the first incident or shared by different vehicles or devices (for example infrastructure sensors or servers). Further, the hash included in the stored information may be used by different party or agencies to authenticate or check integrity of the data related to the first incident.

At 428, the electronic device 102 may be configured to retrieve similar incident reports from the distributed ledger 120. The similar incident reports related to other incidents (i.e. other than the first incident) may provide information about common problems experienced by the vehicles, such as the autonomous vehicles during testing phase, as well as, during driving phase of the vehicle. In some embodiments, the electronic device 102 may be configured to retrieve similar incident reports which may be relevant for the same location at which the first incident occurred, or similar past reports associated with the first vehicle 302, or similar reports associated with vehicles of same manufactures as of the first vehicle 302.

At 430, the processor 202 of the electronic device 102 may be configured to determine regulation information of a vehicle, such as the first vehicle 302 (for example an autonomous vehicle). In accordance with an embodiment, the processor 202 may determine the regulation information based on the plurality of reports stored on the distributed ledger. The plurality of reports may include the first report, the second report, the conclusive incident report and other similar reports.

In an exemplary embodiment, the first vehicle 302 may be a new generation car, such as an autonomous car. The efficient implementation of the autonomous cars in the existing traditional non-autonomous vehicle system may require regulation information associated with the autonomous cars. The regulation information may be applied to the first vehicle 302 when the first vehicle 302 experiences the first incident. The regulation information may be utilized for regulation of policies and traffic control that may be applied to the existing traditional non-autonomous vehicle systems as well as the new generation vehicles (like autonomous). For example, the regulation information may include, but is not limited to, safety measures related to design of vehicles, operations conditions (like speed, temperature, time, altitude, pressure, or location) under which a vehicle should effectively operate, object detection rules for autonomous vehicle, safety measure to be taken at time of problems or collisions, mitigation rules for safety risks, rules related to security, data acquisition & recording rules, or guidelines related to federal, state, or local laws. The present disclosure allows determination of the regulation information by use of the conclusive incident report stored securely on the distributed ledger 120. The electronic device 102 may be configured to determine a particular regulation, as the regulation information, which may be learned based on the conclusive incident report, and further applied to a particular authority (like a manufacturer of vehicle, a transport authority, an insurance company, or a government agency) to avoid the first incident in future to an extent. The parties involved in providing details of the conclusive incident report not only includes vehicles, but may also include infrastructure sensors, such as the traffic light systems (for example, the first traffic light system 304D, the second traffic light system 304E and the CCTV camera 304F). Such information shared by the multiple parties (within a particular zonal range) may ensure that only reliable, accurate, and secure information is being stored on the distributed ledger 120 to be further used by the third parties, such as the insurance companies, the government agencies, the automobile manufactures, the traffic authorities and so forth to apply the regulation based on the determined regulation information.

At 432, the processor 202 of the electronic device 102 may be configured to apply a particular regulation indicated by the determined regulation information. In some embodiments, the processor 202 may send the determined regulation information to a particular party for application of the determined regulation to avoid future incidents (for example accidents, technical failures in vehicle or infrastructure sensors, or traffic jams). In an example, based on analysis of the conclusive incident reports of multiple incidents, the electronic device 102 may determine that the autonomous vehicles of a particular manufacture may not be able correctly recognize red color in the traffic light which may be a major cause of the corresponding accidents in a particular area. Thus, the disclosed electronic device 102 may determine the regulation information, as polices or rules, for the manufacture of the vehicles to enhance color recognition or object detection technique for existing or future generated vehicles. The manufacture may apply the determined regulation during manufacturing to further enhance the object detection technique in future autonomous vehicles. In an example, regulations for the transport authority may be determined or applied, that a particular autonomous vehicle may only be registered or authorized, until the vehicle passes color detection or object detection tests in recent road situations.

In an exemplary embodiment, the insurance companies may utilize the conclusive incident report related to the first incident in the distributed ledger 120 or regulation information for insurance claim investigation. Moreover, the insurance company, such as a vehicle insurance company may determine cause of the first incident, fault of the person driving the vehicle, fault of the manufacturer of the vehicle, fault of the infrastructure and the like, to collect information related to the insurance claim. In another exemplary embodiment, the automobile manufactures may utilize the conclusive incident report or the determined regulation information for improvements in the autonomous vehicles and advanced driving assistant systems (ADAS).

FIG. 5 collectively illustrate a flowchart of an example method for determination of automobile regulation based on distributed ledger, according to at least one embodiment described in the present disclosure. FIG. 5 is explained in conjunction with elements from FIG. 1, FIG. 2, FIG. 3, and FIGS. 4A-4C. With reference to FIG. 5, there is shown a flowchart 500. The method illustrated in the flowchart 500 may start at 502 and may be performed by any suitable system, apparatus, or device, such as by the example electronic device 102 of FIG. 1 or the processor 202 of FIG. 2. For example, one or more of the electronic device 102, the processor 202 of the electronic device 102, the first communication device 106, the set of second communication devices 108, and the distributed ledger 120 may perform one or more of the operations associated with the method. Although illustrated with discrete blocks, the steps and operations associated with one or more of the blocks of the method may be divided into additional blocks, combined into fewer blocks, or eliminated, depending on the particular implementation.

At block 502, an occurrence of the first incident related to the first vehicle 302 may be detected. In some embodiments, the first vehicle 302 may be an autonomous vehicle and the first incident corresponds to, but is not limited to, a technical failure associated with the first vehicle 302, an accident, or a traffic jam. In some embodiments, the occurrence of the first incident related to the first vehicle 302 may be detected by the processor 202 of the electronic device 102. The processor 202 may receive a user input from the user 122 (shown in FIG. 1) to detect the occurrence of the first incident. In some embodiments, the processor 202 may receive information from the first vehicle 302 to detect the occurrence of the first incident. Example of the first incident is described in detail, for example, in FIG. 3.

At block 504, the first report related to the first incident may be received from the first communication device 302A which may be associated with the first vehicle 302. In an embodiment, the processor 202 of the electronic device 102 may be configured to receive the first report about the first incident from the first communication device 302A of the first vehicle 302. In some embodiments, the first communication device 302A may be integrated with the first vehicle 302 as shown in the FIG. 3. In one or more embodiments, the first communication device 302A may be separate from the first vehicle 302 and may be communicatively coupled to the first vehicle 302. The receipt of the first report is described in detail, for example, in FIGS. 4A-4C.

At block 506, the received first report and request for the second report may be shared with the set of second communication devices 108. In one or more embodiments, the processor 202 of the electronic device 102 may be configured to share the first report (i.e. received from the first communication device 302A or retrieve from the distributed ledger 120), with the set of second communication devices 108. In one or more embodiments, the processor 202 of the electronic device 102 may further request the second report from each of the set of second communication devices 108. The transmission of the received first report and request sent to the set of second communication devices 108 for the second report are described in detail, for example, in FIGS. 4A-4C.

At block 508, it may be determined whether each of the set of second communication devices 108 lie in the first zonal range 314 of the first vehicle 302. In one or more embodiments, the processor 202 may determine whether each of the set of second communication devices 108 lie within the first zonal range 314 of the first vehicle 302 based on locations of the set of second communication devices 108 at the time of the first incident. The locations may be received from the set of second communication devices 108, or may be retrieved from the memory 204 or may be requested from the navigation server 114B which may provide geo-locations of each of the set of second communication devices 108 at the time of the first incident. In case of determination of a communication device (for example the external communication device 308A as shown in FIG. 3) from the set of second communication devices 108 that is not in the first zonal range 314, the control passes to block 510. Otherwise, the control passes to block 512

At block 510, the second reports received from the communication device (of the set of second communication devices 108) that lie outside the first zonal range 314 may be rejected. In one or more embodiments, the processor 202 may be configured to reject the second report received from the communication device (for example the external communication device 308A) that may lie outside the first zonal range 314. The second report received from the communication device (that lie outside the first zonal range 314) are rejected to avoid communication of irrelevant information related to the first incident. In one or more embodiments, the processor 202 of the electronic device 102 may also receive second report from a communication device of a vehicle or an infrastructure sensor which may fail authorization with the distributed ledger 120 or associated smart contract. In such case, the processor 202 may reject the second report obtained from such communication device due to failed authorization. The rejection of the irrelevant second reports is described in detail, for example, in FIGS. 4A-4C.

At 512, the second report may be received from one or more of the set of second communication devices 108 (that are in the first zonal range 314 at the time of occurrence of the first incident). In one or more embodiments, the processor 202 may be configured to receive the second report from the one or more of the set of second communication devices 108 that may be within the first zonal range 314 from the first incident related to the first vehicle 302. In other words, the electronic device 102 may select or accept the second report received from the one or more of the set of second communication devices 108 that lie within the first zonal range 314. In one or more embodiments, the selected second reports may contribute for collection of accurate or relevant information of the first incident related to the first vehicle 302. The reception of the second report from the one or more communication devices of the set of second communication devices 108 that are in the first zonal range 314 is described in detail, for example, in FIGS. 4A-4C.

At 514, the received first report and the second report may be transmitted to the distributed ledger 120 for storage or the execution of the associated smart contract. In one or more embodiments, the processor 202 may be configured to control the transmission of the received first report and the second reports to the distributed ledger 120. In one or more embodiments, the execution of the smart contract may authorize the identity of the first communication device 106 associated with the first vehicle 302 and the each of the set of second communication devices 108. The transmission of the reports to the distributed ledger 120, the authorization of the first communication device 106 and the set of second communication devices 108, and the validation of the first report and the second reports are described in detail, for example, in FIGS. 4A-4C. In some embodiments, the distributed ledger 120 may be configured to securely store the reports for each incident associated with the first vehicle 302 or the set of second communication devices 108, and may further add the smart contract for each incident, associated vehicles, communication devices, and/or infrastructure sensors.

At block 516, the consensus information may be generated based on the first report, the second reports and the execution of the smart contract on the distributed ledger 120. In one or more embodiments, the processor 202 may be configured to generate the consensus information to allow determination of the accurate details of the first incident related to the first vehicle 302. The generation of the consensus information is described in detail, for example, in FIGS. 4A-4C.

At block 518, the conclusive incident report may be generated for the first incident associated with the first vehicle 302 based on the generated consensus information. In one or more embodiments, the processor 202 may be configured to generate the conclusive incident report for the first incident based on the generated consensus information as described, in detail, for example, in FIGS. 4A-4C. In one or more embodiments, the conclusive incident report, the first report and the second report may be stored on the distributed ledger 120. The plurality of reports such as the conclusive incident report, the first report and the second report may be used to determine the regulation information for application of a regulation on a particular party (for example manufacturer of vehicle, transport authority, or government agency) as described in detail, for example, in FIGS. 4A-4C.

Control passes to end. Although the flowchart 500 is illustrated as discrete operations, such as 502, 504, 506, 508, 510, 512, 514, 516 and 518. However, in certain embodiments, such discrete operations may be further divided into additional operations, combined into fewer operations, or eliminated, depending on the particular implementation without detracting from the essence of the disclosed embodiments.

Various embodiments of the disclosure may provide one or more non-transitory computer-readable storage media configured to store instructions that, in response to being executed, cause an electronic device (such as the example electronic device 102) to perform operations. The operations may include receiving a first report from a first communication device, wherein the first report is related to a first incident associated with a first vehicle corresponding to the first communication device. The operations may further include receiving a second report from each of a set of second communication devices different from the first communication device. The each of the set of second communication devices lies within a first zonal range of the first vehicle. The second report is related to the first incident associated with the first vehicle. The operations may further include transmitting the first report received from the first communication device and the second report received from one or more of the set of second communication devices to a distributed ledger communicatively coupled to the electronic device. Furthermore, the operations may include generating consensus information to validate the first incident, based on a smart contract, the received first report, and the received second report. The smart contract executed on the distributed ledger is associated with each of the first communication device and the one or more set of second communication devices. The operations may further include generating a conclusive incident report related to the first incident based on the generated consensus information.

As used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated. In this description, a “computing entity” may be any computing system as previously defined in the present disclosure, or any module or combination of modulates running on a computing system.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

What is claimed is:

1. An electronic device, comprising:
a processor configured to:
receive a first report from a first communication device, wherein the first report is related to a first incident which is associated with a first vehicle corresponding to the first communication device;
receive a second report from each of a set of second communication devices different from the first communication device, wherein each of the set of second communication devices lies within a first zonal range of the first vehicle, and wherein the second report is related to the first incident associated with the first vehicle;
transmit the first report received from the first communication device and the second report received from one or more of the set of second communication devices to a distributed ledger communicatively coupled to the electronic device;
generate consensus information to validate the first incident, based on a smart contract, the received first report, and the received second report,
wherein the smart contract executed on the distributed ledger is associated with each of the first communication device and the one or more of the set of second communication devices; and
generate a conclusive incident report related to the first incident based on the generated consensus information.

2. The electronic device according to claim 1, wherein the first vehicle corresponds to an autonomous vehicle.

3. The electronic device according to claim 1, wherein the processor is further configured to determine regulation information based on a plurality of reports stored on the distributed ledger, wherein the plurality of reports comprise at least one of: the conclusive incident report, the first report, or the second report.

4. The electronic device according to claim 1, wherein the processor is further configured to update the distributed ledger with the conclusive incident report of the first incident.

5. The electronic device according to claim 1, wherein the processor is further configured to transmit the received first report related to the first incident to the set of second communication devices.

6. The electronic device according to claim 1, wherein the set of second communication devices comprise at least one of: a communication device associated with a second vehicle different from the first vehicle, a traffic light system, an image capturing device, another electronic device associated with a person, or one or more first servers located with a second zonal range which includes the first zonal range.

7. The electronic device according to claim 6, wherein the processor is further configured to receive the second report from one or more second servers associated the set of second communication devices.

8. The electronic device according to claim 1, wherein the first report and the second report related to the first incident comprise at least one of: sensor data associated with the first vehicle, one or more images associated with the first incident, geographical location of the first incident, environmental data, navigation information, a description of cause of the first incident, or information about a set of parties involved in the first incident.

9. The electronic device according to claim 1, wherein the first report and the second report comprise at least one of public information and private information associated with the first incident.

10. The electronic device according to claim 1, wherein the processor is further configured to:
transmit a request to the set of second communication devices to share the second report based on the first report received from the first communication device; and
receive the second report from each of the set of second communication devices based on the transmitted request.

11. The electronic device according to claim 1, wherein the processor is further configured to:
receive the second report, related to the first incident, from an external communication device, wherein the external communication device lies outside the first zonal range of the first vehicle at a time of the first incident; and
reject the second report received from the external communication device based on a determination that the external communication device lies outside the first zonal range of the first vehicle at the time of the first incident.

12. The electronic device according to claim 1, wherein the processor is further configured to:
validate an authorization of each of the set of second communication devices based on the smart contract associated with each of the set of second communication devices; and
select the one or more of the set of second communication devices based on the validation.

13. The electronic device according to claim 11, wherein the processor is further configured to reject the second report received from a communication device of the set of second communication devices based on the validation, wherein the communication device is different from the one or more of the set of second communication devices.

14. The electronic device according to claim 1, wherein the processor is further configured to communicate with the first communication device and each of the set of second communication devices, via an application programming interface (API).

15. A method, comprising:
in an electronic device:
receiving a first report from a first communication device, wherein the first report is related to a first incident which is associated with a first vehicle corresponding to the first communication device;
receiving a second report from each of a set of second communication devices different from the first communication device, wherein each of the set of second communication devices lies within a first zonal range of the first vehicle, and wherein the second report is related to the first incident associated with the first vehicle;
transmitting the first report received from the first communication device and the second report received from one or more of the set of second communication devices to a distributed ledger communicatively coupled to the electronic device;
generating consensus information to validate the first incident, based on a smart contract, the received first report, and the received second report,
wherein the smart contract executed on the distributed ledger is associated with each of the first communication device and the one or more of the set of second communication devices; and
generating a conclusive incident report related to the first incident based on the generated consensus information.

16. The method according to claim 15, further comprising determining regulation information based on a plurality of reports stored on the distributed ledger, wherein the plurality of reports comprise at least one of: the conclusive incident report, the first report, or the second report.

17. The method according to claim 15, wherein the set of second communication devices comprise at least one of: a communication device associated with a second vehicle different from the first vehicle, a traffic light system, an image capturing device, another electronic device associated with a person, or one or more first servers located with a second zonal range which includes the first zonal range.

18. The method according to claim 15, wherein the first report and the second report related to the first incident comprise at least one of: sensor data associated with the first vehicle, one or more images associated with the first incident, geographical location of the first incident, environmental data, navigation information, a description of cause of the first incident, or information about a set of parties involved in the first incident.

19. The method according to claim 15, further comprising:
validating an authorization of each of the set of second communication devices based on the smart contract associated with each of the set of second communication devices; and
selecting the one or more of the set of second communication devices based on the validation.

20. One or more non-transitory computer-readable storage media configured to store instructions that, in response to being executed, cause an electronic device to perform operations, the operations comprising:
receiving a first report from a first communication device, wherein the first report is related to a first incident which is associated with a first vehicle corresponding to the first communication device;
receiving a second report from each of a set of second communication devices different from the first communication device, wherein each of the set of second communication devices lies within a first zonal range of the first vehicle, and wherein the second report is related to the first incident associated with the first vehicle;
transmitting the first report received from the first communication device and the second report received from one or more of the set of second communication devices to a distributed ledger communicatively coupled to the electronic device;
generating consensus information to validate the first incident, based on a smart contract, the received first report, and the received second report,
wherein the smart contract executed on the distributed ledger is associated with each of the first communication device and the one or more of the set of second communication devices; and
generating a conclusive incident report related to the first incident based on the generated consensus information.
